(19) United States
(12) Patent Application Publication
(10) Pub. No.: US 2017/0046810 A1
(43) Pub. Date: Feb. 16, 2017

(54) ENTRAPMENT-RISK RELATED INFORMATION BASED ON VEHICLE DATA

(71) Applicant: GM GLOBAL TECHNOLOGY OPERATIONS LLC, Detroit, MI (US)

(72) Inventor: Stephane VITET, Ruesselsheim (DE)

(73) Assignee: GM GLOBAL TECHNOLOGY OPERATIONS LLC, Detroit, MI (US)

(21) Appl. No.: 15/236,536

(22) Filed: Aug. 15, 2016

(30) Foreign Application Priority Data
Aug. 13, 2015 (GB) 1514402.5

(51) Int. Cl. G06Q 50/26; G07C 5/08; G07C 5/00; G06N 5/04; G06N 7/00

(52) U.S. Cl. CPC G06Q 50/265; G06N 5/04; G06N 7/005; G07C 5/008; G07C 5/08

(57) ABSTRACT

A method and system for processing vehicle data to respond to a vehicle crash is provided, vehicle data obtained from at least one vehicle is received. An entrapment-risk parameter indicative of an entrapment risk is estimated based on the vehicle data. Information related to an entrapment risk based on the entrapment-risk parameter is communicated to an emergency response point.

### CROSS-REFERENCE TO RELATED APPLICATION

This application claims priority to British Patent Application No. GB1514402.5, filed Aug. 13, 2016, which is incorporated herein by reference in its entirety.

### TECHNICAL FIELD

The present disclosure pertains to a method and system for processing vehicle data to provide entrapment-risk related information to an emergency response point and a computer program product including source code recorded on a computer-readable data carrier for carrying out the method.

### BACKGROUND

U.S. Pat. No. 8,749,350 B2 discloses a method of processing vehicle crash data, which includes receiving vehicle data obtained during a vehicle crash, estimating a severity of the vehicle crash using the received vehicle data, and graphically depicting the estimated severity on a wireless device used by an emergency responder. The severity may determine a relative ranking with respect to occupant injury, e.g. “low”, “moderate” or “severe”. The information may help the emergency responder to assist vehicle occupants or to prepare therefore in advance.

Some vehicle crashes demand for special rescue tools like hydraulic cutters, flame cutters, pneumatic lifters or the like in order to extricate entrapped passenger from the vehicle. If such necessity for a special rescue tool is determined for the first time when an emergency responder like a regular ambulance or the like not carrying such special equipment arrives at the crash site, additional time will be required until an emergency responder carrying the special rescue tool like a fire engine is ordered and arrives at the crash site.

Such necessity for a special rescue tool does not necessarily correlate with a severity of the vehicle crash as it is estimated in U.S. Pat. No. 8,749,350 B2. For example, the severity may be high or higher if airbags have malfunctioned, an occupant has not been belted or the like, although there only is a small or smaller likelihood of a necessity for a special rescue tool. Vice versa the severity may be low or lower due to airbag protection of belted occupants although there is a large or larger likelihood of a necessity for a special rescue tool, e.g. due to a roll-over of the vehicle. Similarly, rear impacts may cause a high or higher severity with respect to occupant injury while at the same time there only is a small or smaller risk of entrapment and therefore likelihood of a necessity for a special rescue tool.

### SUMMARY

In accordance with the present disclosure, an improved method and system for processing vehicle data to respond to a vehicle crash is provided. According to one aspect of the present disclosure the method of processing vehicle data includes receiving vehicle data obtained from at least one vehicle at a call center. An entrapment-risk parameter indicative of an entrapment risk based on the vehicle data is estimated, at least partially at the call center and/or automatically using a computer. Entrapment-risk related information is communicated based on the entrapment-risk parameter to an emergency response point.

In another aspect of the present disclosure, a system for processing vehicle data may be adapted for carrying out the method as described herein. The system includes a communication system, receiver, electronic control unit or other means for receiving vehicle data obtained from at least one vehicle. A computer or other means is configured to estimate an entrapment-risk parameter indicative of an entrapment risk based on the vehicle data. The computer, a transmitter, communication system or other means is configured to provide, in particular submitting, entrapment-risk related information based on the entrapment-risk parameter to an emergency response point.

According to one embodiment, such entrapment-risk related information provided to an emergency response point may allow the emergency response point to send out adequate emergency responders carrying special rescue tools for extricating entrapped passenger like fire engines or the like if deemed necessary. Additionally or alternatively such information may prepare such special rescue tools in advance before arriving at the crash site if deemed necessary.

According to one embodiment the vehicle may be a car, in particular a passenger car or a coach. According to one embodiment the vehicle data may be obtained in the event of a crash of the vehicle, in particular during the crash and/or, in particular immediately or directly, before and/or after the crash or an impact.

According to one embodiment the vehicle data may be received and/or the entrapment-risk related information may be submitted wirelessly and the means for receiving vehicle data/submitting entrapment-risk related information may be adapted accordingly.

According to one embodiment the vehicle data based on which the entrapment-risk parameter is estimated may include a vehicle speed parameter indicative of a speed of the vehicle and/or time derivative thereof, in particular a positive or negative acceleration, in particular a direction and/or magnitude of the speed or time derivative respectively. The vehicle speed parameter may in particular be obtained from speed or acceleration sensors, GPS sensors or the like.

Additionally or alternatively the vehicle data based on which the entrapment-risk parameter is estimated may include an impact direction parameter indicative of a direction of impact, in particular a principal direction of impact, which in a particular embodiment may be discretized into two or more, in particular at least four or six, direction sectors, such as “frontal”, “frontal-right”, “frontal-left”, “right”, “left”, “rear-right”, “rear-left” and “rear” or the like. The impact direction parameter may in particular be obtained from acceleration sensors, touch or force sensors or the like.

Additionally or alternatively the vehicle data based on which the entrapment-risk parameter is estimated may include an impact number parameter indicative of a number of impacts, in particular whether the crash has been a single event or includes multiple events or impacts. The impact number parameter may in particular be obtained from acceleration sensors, touch or force sensors or the like.

Additionally or alternatively the vehicle data based on which the entrapment-risk parameter is estimated may include a vehicle type parameter indicative of a type of the vehicle, in particular its class, number or passenger seats or the like, such as “2-seat coupe”, “4-seat limousine”, “4-seat truck”, “12-seat coach” or the like. The vehicle type parameter may in particular be obtained from a vehicle identification or the like.

Additionally or alternatively the vehicle data based on which the entrapment-risk parameter is estimated may include a rollover parameter indicative of a rollover of the vehicle, in particular whether the vehicle has experienced one or multiple rollovers. The rollover parameter may in particular be obtained from acceleration sensors, GPS sensors or the like.

Additionally or alternatively the vehicle data based on which the entrapment-risk parameter is estimated may include an occupant parameter indicative of a place occupation, in particular a seat occupation, within the vehicle, in particular whether certain places, in particular seats are or have been occupied before and/or after an impact, and/or which places, in particular seats, have been occupied before and/or after an impact. The occupant parameter may be obtained from seat occupation sensors, safety belt buckle sensors, passenger compartment monitoring sensors or the like.

An entrapment risk may be higher or an entrapment-risk parameter may be larger respectively if an occupant parameter indicates that one or more seats facing an impact (side) are or have been occupied than if no seats located beside or near an impact (side) have been occupied. If for example an impact direction parameter indicates a right-side impact and an occupant parameter indicates that a right front seat and/or right rear seat has been occupied before and/or after an impact, than the entrapment risk may be estimated higher or an entrapment-risk parameter may be estimated larger respectively for the same other vehicle data components like (time derivative of) vehicle speed and the like than if the occupant parameter indicates that no seat on the vehicle's right, impacted side has been occupied. It has turned out that in one or more of these parameters or combinations thereof, may allow an advantageous forecast whether there is a necessity of a special rescue tool or not.

According to one embodiment the entrapment-risk parameter indicates a necessity of one or more predetermined rescue tools to extricate one or more passengers from the vehicle, in particular a likelihood or probability thereof.

The entrapment-risk parameter may be one- or multi-dimensional. According to one embodiment it may indicate whether there is at least a minimal likelihood of a necessity of any rescue tool, which is not regularly carried by a certain emergency responder, i.e. the entrapment-risk parameter may be a Boolean “likely” or “not likely”. According to a more advanced embodiment the entrapment-risk parameter may further quantify the likelihood of a necessity of any rescue tool which is not regularly carried by a certain emergency responder, i.e. the entrapment-risk parameter may be a number, in particular between 0 and 1 or 0% and 100%, wherein 0 or 0% may indicate that it is very unlikely that any or some special rescue tool will be needed at the crash site and 1 or 100% may indicate that it is very likely or almost certain that any or some special rescue tool will be needed at the crash site. Additionally or alternatively the entrapment-risk parameter may further quantify the likelihood of a necessity of one or more specific rescue tools, e.g. a likelihood of a necessity of hydraulic cutter, a likelihood of a necessity of a flame cutter, a likelihood of a necessity of a pneumatic lifter or the like, in particular by Boolean or a number, in particular between 0 and 1 or 0% and 100%, for each tool.

The entrapment-risk related information based on the entrapment-risk parameter may include the entrapment-risk parameter itself. This may allow the emergency response point to further process the entrapment-risk parameter and compare it to predetermined thresholds for sending out specific emergency responders or the like. According to another embodiment, the entrapment-risk related information may be determined by further processing the entrapment-risk parameter by comparing it to predetermined thresholds or the like for providing entrapment-risk related information adapted thereto. Thereby, the emergency response point may be provided by a condensed information like “some special rescue tool(s)/fire engine probably needed/not needed”, “hydraulic cutter probably needed/not needed” or the like.

According to one embodiment the entrapment-risk parameter is estimated based on a predetermined relation between the vehicle data and the entrapment-risk parameter. The relation may in particular be a functional relationship in the form of

ERP[%]=F(x1,x2, . . . ,xn)

where:

ERP denotes the entrapment-risk parameter in percent,

xi denotes a vehicle data component like one of the parameters mentioned above, for example a vehicle speed parameter Δv, an impact direction parameter PDI (“Principal Direction of Impact”), an impact number parameter, a vehicle type parameter, a rollover parameter or the like, and

F denotes a function, which in a particular embodiment may have the form of

$$ERP [ \% ] = \frac{1}{\underbrace{1 + {e}^{{b}_{0} + {b}_{1} \cdot Δv ++ {b}_{2} \cdot PDI + … + {b}_{n} \cdot {x}_{n}}}_{F ( {x}_{1 , … {x}_{n} )}}}$$

The function has turned out to fit real vehicle data and entrapment risk well. However, the present disclosure is not restricted to the particular relation but may be implemented in different form. For example, the received vehicle data may be compared to different sets of vehicle data of past crash events and the entrapment-risk parameter may be estimated by a k-neighbor method or the like, counting the sets of vehicle data lying within a predetermined radius around the received vehicle data and evaluating whether or what special rescue tools have been needed at these crash events.

According to one embodiment the relation may be predetermined in advance, based on a data base of past crash events including entrapment-related extrication actions and vehicle data of different past crash events, in particular by determining parameters of a function like for example the one explained above by a regression analysis of the data base.

According to one aspect of the present disclosure, the system may be implemented by software, in particular a computer program or computer program module, and/or hardware, in particular a computer or central processing unit which is configured to carry out a method described herein, one or more sensors communicating with and controlled by, the computer or central processing unit, or a computer program product, in particular a data carrier and a data storage device respectively, including program code which implements a method described herein when running on a computer or central processing unit. The computer program or computer program module may be stored on the data carrier and the data storage device respectively in particular in a non-transitory and/or non-volatile way. The system may also be understood as including means in terms of function module architecture that is to be realized or implemented by the computer program or computer program module.

According to one embodiment the emergency response point may includes a public or private, in particular commercial, safety answering point and/or an emergency responder.

### BRIEF DESCRIPTION OF THE DRAWINGS

The present disclosure will hereinafter be described in conjunction with the following drawing figures, wherein like numerals denote like elements.

FIG. 1 shows a system according to an embodiment of the present disclosure;

FIG. 2 shows a method according to an embodiment of the present disclosure, the method being carried out by the system; and

FIG. 3 shows an entrapment-risk parameter ERP over corresponding vehicle data Δv.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

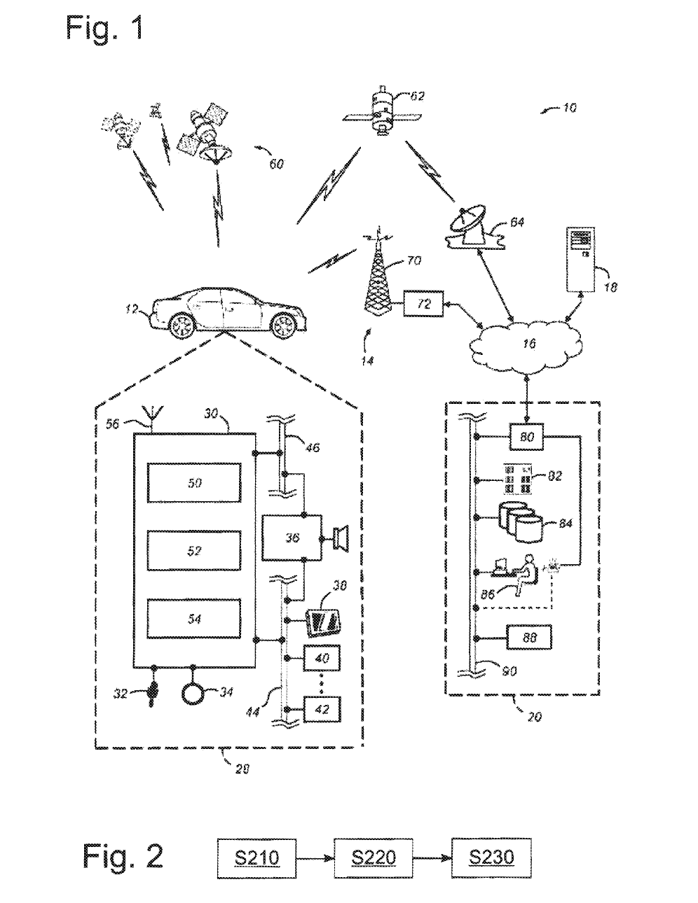

FIG. 1 shows an exemplary operating environment that includes a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, a brief overview of one such exemplary system 10 is provided herein, however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 are shown generally in FIG. 1 and include a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that enables wireless voice and/or data communication over wireless carrier system 14 and via wireless networking so that the vehicle can communicate with call center 20, other telematics-enabled vehicles, or some other entity or device. The telematics unit 30 preferably uses radio transmissions to establish a cellular call (a voice channel and/or a data channel) with wireless carrier system 14 so that voice and/or data transmissions can be sent and received over the call. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM or CDMA standards and thus includes a standard cellular chipset 50 for voice communications like hands-free calling, a vocoder, a wireless modem for data transmission, an electronic processing device 52, one or more digital memory devices 54, and a dual antenna 56. It should be appreciated that the modem can either be implemented through software that is stored. in the telematics unit and is executed by processor 52, or it can be a separate hardware component located internal or external to telematics unit 30. The modem can operate using any number of different standards or protocols such as EVDO, CDMA, GSM, GPRS, and EDGE. Wireless networking between the vehicle and other networked devices can also be carried out using telematics unit 30. For this purpose, telematics unit 30 can be configured to communicate wirelessly according to one or more wireless protocols, such as any of the IEEE 802.11 protocols, WiMAX, or Bluetooth. When used for packet-switched data communication such as TCP/IP, the telematics unit can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module; diagnostic reporting using one or more diagnostic modules; and infotainment-related services where music, webpages, movies, television programs, videogames and/or other information is downloaded by an infotainment module and is stored for current or later playback. The above-listed services are not intended as an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit 30.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented audibly such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. VSM 42 can also be a crash detection module and/or include one or more vehicle sensors that are capable of detecting a vehicle crash. In one example, a vehicle sensor capable of detecting a vehicle crash can be an accelerometer or other device capable of sensing change in vehicle motion and/or direction. However, other sensors are possible. Vehicle sensors that are capable of detecting a vehicle crash can be included in the vehicle electronics 28 to provide vehicle crash detection information to the telematics unit 30. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using a voice or packet-switched data connection, telematics unit 30 can use SMS to send and receive data. Also, apart from using wireless carrier system 14, a different wireless carrier system in the form of satellite communication can be used to provide uni-directional or bi-directional communication with the vehicle This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30 (e.g. a data center); a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. The call center 20 is given as one example of a central facility and it should be appreciated that other implementations are possible. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VOW as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize NTRS 88 as an automated advisor or, a combination of VRS 88 and the live advisor 86 can be used.

Call center 20 includes or is a system according to an embodiment of the present disclosure carrying out a method according to an embodiment of the present disclosure described with reference to FIG. 2 in the following or adapted thereto respectively. Accordingly, its elements, in particular switch(es) 80, server(s) 82, database(s) 84 and network 90 and/or a computer program stored on a computer program product therein may include, in particular be, a means of a system according to an embodiment of the present disclosure.

Turning now to FIG. 2, there is an exemplary method according to an embodiment of the present disclosure.

The method 200 begins at block 210 with receiving vehicle data xi obtained from vehicle 12 in the event of a crash of the vehicle. In particular, a vehicle crash may be detected using of one or more sensors, such as those previously-described as providing input to VSM 42, that indicate that the vehicle 12 has been involved in a collision. For instance, these sensors can detect one or more vehicle events that occur during a crash. Such events include airbag activation, a change in vehicle velocity or acceleration/deceleration larger than a predetermined threshold, or detecting a vehicle rollover to name a few. Once the sensor and/or VSM 42 has received input indicating a vehicle crash has occurred, this input can be sent via the vehicle bus 44 to the telematics unit 30. There, the telematics unit 30 can interpret one or more inputs received from the sensor and determine if a vehicle crash has occurred. Alternatively, the determination that a collision occurred can be made at the crash module VSM 42 and a notification of such sent to the telematics unit 30.

Vehicle crash data gathered during the vehicle crash is sent from the vehicle 12. After determining that a vehicle crash has occurred, vehicle data obtained before, during, and after the crash can be preserved and will be generally referred to as vehicle crash data. This means that data representing vehicle motion and operation can be continuously gathered and when a collision occurs, the data before, during, and after the crash can be identified and preserved. This vehicle crash data can be identified as Advanced Automatic Collision Notification (AACN) or Automatic Crash Response (ACR) data. ACR data can include vehicle telemetry that is sent from the vehicle 12 when a vehicle is involved in a crash.

Examples of ACR data include information indicating a vehicle speed parameter Δv indicative of a speed of the vehicle and/or time derivative thereof, an impact direction parameter indicative of a direction of impact, an impact number parameter indicative of a number of impacts, a vehicle type parameter indicative of a type of the vehicle and a rollover parameter indicative of a rollover of the vehicle. These are but some examples of ACR data and it will be appreciated by those skilled in the art that the ACR data used by the method can include other useful data. The vehicle crash data can also include or be accompanied by vehicle location information. This information can include GPS coordinates corresponding to the location of the vehicle 12.

The identity of the vehicle is determined. As well as the information described above, the ACR data can also or alternatively include information that identifies and/or describes the vehicle 12. In one example, this means that the ACR data can incorporate vehicle identity information, such as the vehicle model, the manufacturer of the vehicle, and the year of manufacture. In another example, the ACR data can include a unique identifier, such as a vehicle identification number (VIN), electronic serial number (ESN), or station identification number (STID) to name a few. The unique identifier can be used at a location outside of the vehicle, such as the call center 20, to retrieve telematics subscriber information. That is, the unique identifier can be used to reference or gain access to the vehicle model, manufacturer, and year of manufacture or other personal data belonging to the telematics subscriber. In yet another example, the call center 20 can identify the telephone number of an incoming call and use that identification to determine the vehicle model, the manufacturer of the vehicle, and the year of manufacture of the vehicle in the crash. Regardless of whether identifying information, such as the vehicle model, the manufacturer of the vehicle, and the year of manufacturer, is sent with the ACR data from the vehicle 12 or accessed outside of the vehicle 12, the identifying information, the unique identifier, or the telephone number can be leveraged to identify specific vehicle components installed on the vehicle 12 involved in the crash.

At block S220 an entrapment-risk parameter ERP is estimated based on a predetermined relation or function F between the vehicle data xi and the entrapment-risk parameter ERP. The entrapment-risk parameter ERP indicates a likelihood of a necessity of some special rescue tool to extricate a passenger from the vehicle. By way of example the predetermined relation F may have the form of

$$ERP [ \% ] = \frac{1}{\underbrace{1 + {e}^{{b}_{0} + {b}_{1} \cdot Δv ++ {b}_{2} \cdot PDI + … + {b}_{n} \cdot {x}_{n}}}_{F ( {x}_{1 , … {x}_{n} )}}}$$

where:

ERP denotes the entrapment-risk parameter in percent;

xi denotes a vehicle data component like one of the parameters mentioned above, for example the vehicle speed parameter Δv, the impact direction parameter PDI (“Principal Direction of Impact”), the impact number parameter, the vehicle type parameter, the rollover parameter or the like; and

F denotes a functional relationship.

The functional relationship F may be predetermined in advance based on data base 84 of past crash events including entrapment-related extrication actions and vehicle data of different past crash events.

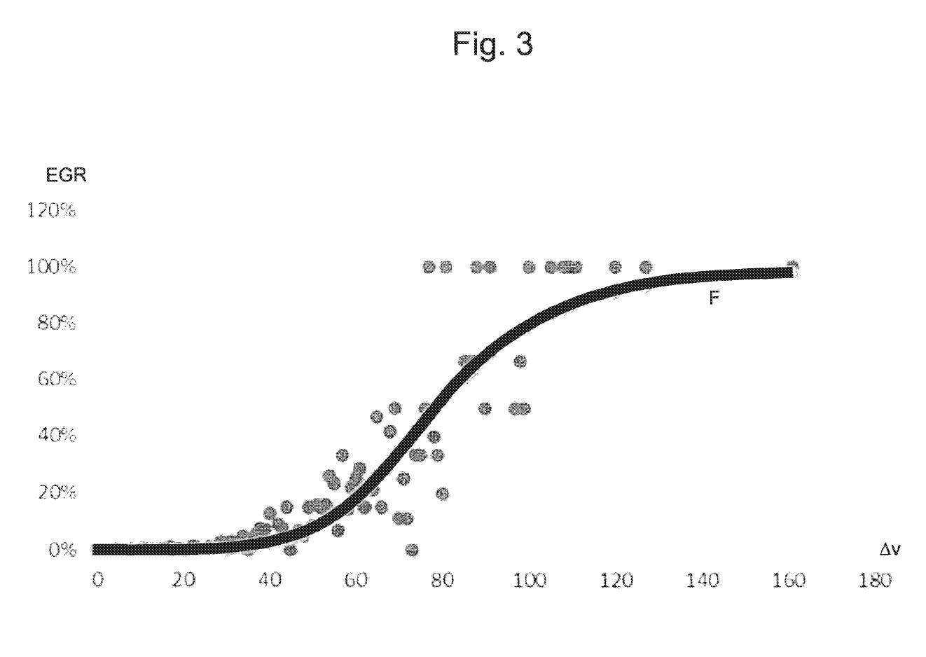

For example, for some or all past crash events of the database 84 it may in advance be determined whether for at least one occupant of the respective vehicle any special rescue tool was needed to extricate the occupant. In case any special rescue tool was needed to extricate at least one occupant of the respective vehicle, this past crash event is marked as ER-positive, otherwise marked as ER-negative. Then for each combination of vehicle data component ranges, the number of ER-positives whose vehicle data fall within the range is summarized and the sum is divided to the sum of all past crash events within the range, i.e. the sum of all ER-positives and ER-negatives, and the quotient is stored as the entrapment-risk parameter ERP corresponding to the combination of vehicle data component ranges. Afterwards, constants b0, . . . , bn of functional relationship F are determined by a regression analysis to best-fit the so-determined distribution of entrapment-risk parameter values ERP over corresponding vehicle data. As an example, FIG. 3 shows the entrapment-risk parameter values ERP(Δv, PDI=“side impact”) over corresponding vehicle speed parameter Δv for side impact and the functional relationship F fitted thereto. By filling in the vehicle data xi received at block S210 into the formula F given above, in block S220 the actual entrapment-risk parameter value ERP(xi) for the current crash event is estimated.

In block S230, the entrapment-risk parameter value ERP(xi) is submitted to a Public Safety Answering Point 86, 88 as an entrapment-risk related information. The information enables Public Safety Answering Point to dispatch a fire engine carrying different special rescue tools to the crash site if this is deemed necessary due to the entrapment risk estimated from the received vehicle data. The emergency responders within the fire engine may prepare the special rescue tools like a hydraulic cutter, flame cutters, pneumatic lifter or the like if this is deemed necessary due to the entrapment risk estimated from the received vehicle data. Thus, in particular the Public Safety Answering Point 86, 88 and/or emergency responders may establish an emergency response point in the sense of the present disclosure.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-13. (canceled)

14. A method of processing vehicle data comprising:
receiving vehicle data obtained from a vehicle that has been involved in at least one impact;
estimating an entrapment-risk parameter indicative of an entrapment risk based on said vehicle data; and
providing entrapment-risk related information based on said entrapment-risk parameter to an emergency response point.

15. The method according to claim 14, wherein said vehicle data from which said entrapment-risk parameter is estimated comprises at least one of a vehicle speed parameter indicative of a speed of the vehicle or a time derivative of the vehicle speed parameter, an impact direction parameter indicative of a direction of the impact, an impact number parameter indicative of a number of impacts, a vehicle type parameter indicative of a type of the vehicle, a rollover parameter indicative of a rollover of the vehicle or an occupant parameter indicative of a place occupation within the vehicle.

16. The method according to claim 14, wherein said entrapment-risk parameter indicates a likelihood that at least one predetermined rescue tool to extricate at least one occupant from the vehicle.

17. The method according to claim 14, wherein said entrapment-risk parameter is estimated based on a predetermined relation between said vehicle data and said entrapment-risk parameter.

18. The method according to claim 17, wherein said relation is predetermined based on a database of past crash events comprising entrapment-related extrication actions and vehicle data of different past crash events.

19. The method according to claim 18, wherein said vehicle data is obtained in the event of a crash of the vehicle.

20. A non-transitory computer readable medium comprising source code, which when executed on a computer, is configured to carry out the method according to claim 14.

21. A system for processing vehicle data comprising:
means for receiving vehicle data obtained from a vehicle involved in at least one impact;
means for estimating an entrapment-risk parameter indicative of an entrapment risk based on said vehicle data; and
means for providing entrapment-risk related information based on said entrapment-risk parameter to an emergency response point.

22. The according to claim 21, wherein said vehicle data from which said entrapment-risk parameter is estimated comprises at least one of a vehicle speed parameter indicative of a speed of the vehicle, a time derivative of the vehicle speed parameter, an impact direction parameter indicative of a direction of impact, an impact number parameter indicative of a number of impacts, a vehicle type parameter indicative of a type of the vehicle, a rollover parameter indicative of a rollover of the vehicle or an occupant parameter indicative of a place occupation within the vehicle.

23. The system according to claim 21, wherein said entrapment-risk parameter indicates a likelihood that at least one predetermined rescue tool to extricate at least one occupant from the vehicle.

24. The system according to claim 21, further comprising means for estimating said entrapment-risk parameter based on a predetermined relation between said vehicle data and said entrapment-risk parameter.

25. The system according to claim 24, wherein said relation is predetermined based on a database of past crash events comprising entrapment-related extrication actions and vehicle data of different past crash events.

26. The system according to claim 25, wherein said vehicle data are obtained in the event of a crash of the vehicle.
